(19) United States
(12) Patent Application Publication
(10) Pub. No.: US 2022/0301093 A1
(43) Pub. Date: Sep. 22, 2022

(54) METHOD FOR A GAMING SYSTEM

(71) Applicant: Play'n Go Marks Ltd., Sliema (MT)

(72) Inventor: Joakim Lodén, Sliema (MT)

(73) Assignee: Play'n Go Marks Ltd., Sliema (MT)

(21) Appl. No.: 17/697,272

(22) Filed: Mar. 17, 2022

(30) Foreign Application Priority Data
Mar. 18, 2021 (SE) 2150310-7

(51) Int. Cl. G06Q 50/34; G07F 17/32

(52) U.S. Cl. CPC G06Q 50/34; G07F 17/32

(57) ABSTRACT

The present disclosure relates to a computer implemented method performed by a gaming system. In particular, the present disclosure relates to a method specifically handling a process for ranking a plurality of electronic user devices each involved in a game, possibly being different games. The present disclosure also relates to a corresponding electronic gaming system and a computer program product.

### CROSS-REFERENCE TO RELATED APPLICATIONS

This application claims priority to Swedish Patent Application No. 2150310-7, filed on Mar. 18, 2021. The disclosure of the above application is incorporated herein by reference in its entirety.

### TECHNICAL FIELD

The present disclosure relates to a computer implemented method performed by a gaming system. In particular, the present disclosure relates to a method specifically handling a process for ranking a plurality of electronic user devices each involved in a game, possibly being different games. The present disclosure also relates to a corresponding electronic gaming system and a computer program product.

### BACKGROUND

Games of chance are known and widely played for recreational purposes. The gaming industry has come to recognize that to sustain long term success it must be constantly innovative in introducing new games and new gambling concepts to the gaming public. One example of this innovating drive can be appreciated in the embrace of the Internet and online gaming by the gaming industry.

A common trend within the online gaming industry is to provide potentially new and current players with new means for attracting and ensuring that players remain at the online site providing the games. An example of such a means is the use of leaderboards. Leaderboards are used as scoreboards for players to keep track of their scores or winnings in a wagering game. A leaderboard can encourage a spirit of competition among players by comparing and ranking a top set of players based on scores, starting with a highest scoring player to a lowest scoring player. Leaderboard have historically promoted winnings and top players based on highest scores. They are therefore generally limited in attracting the best and top players on a particular game or games. Accordingly, there is a need for a more comprehensive method for allowing a vast plurality of players to possibly join in a common leaderboard.

### SUMMARY

According to an aspect of the present disclosure, the above is at least partly met by a computer implemented method performed by a gaming system, the gaming system comprising a server arranged in communication with a plurality of electronic user devices using a network connection, the plurality of electronic user devices each provided with a display unit adapted to present a graphical user interface (GUI), wherein the method comprises the steps of receiving, at the server, a request from a first electronic user device of the plurality of electronic user devices to enter into one of a plurality of games provided by the server, the request comprising a selection of a first one of the plurality of games and a bet for the selected first game, executing, at the server, the first selected game with the bet, determining, at the server, an outcome of the executed first selected game, wherein the outcome can be one of favorable and unfavorable, determining, at the server, a first score for the first electronic user device, wherein the first score is determined by at least one of accumulating a number of consecutive unfavorable outcomes before a subsequent favorable outcome, and dividing an accumulated number of consecutive unfavorable outcomes by a multiplication factor of a favorable outcome, ranking, at the server, the plurality of electronic user devices in a leaderboard based on a comparison of the first score with a plurality of corresponding scores for the remaining plurality of electronic user devices, including providing each of the plurality of electronic user devices with a ranking level within the leaderboard, wherein a low first score is defined as an unfavorable outcome and is ranked higher than a high first score, and a high first score is defined as a favorable outcome, forming, at the server, a graphical representation of the leaderboard, distributing, from the server to the plurality of electronic user devices, the graphical representation of the leaderboard and directing, using the server, the plurality of electronic user devices to display the graphical representation of the leaderboard within the GUI of each of the plurality of electronic user devices.

The general concept of the present disclosure is based on the fact that it may be possible to improve the attraction to a gaming concept by creating a leaderboard that focuses on unfavorable outcomes as opposed to favorable outcomes allowing for players who are not receiving these favorable outcomes to compete for an alternate prize. In line with the present disclosure, only unfavorable outcomes of a bet will be used to form a specific score for that player playing a specific game within the leaderboard. An in comparison low first score will thus be ranked higher as related to an in comparison high first score. Thus, the leaderboard sorts the electronic user devices with the most unfavorable outcomes higher as compared to the electronic user devices having less or no unfavorable outcomes.

For ensuring that the determination of the outcome (i.e. being favorable and unfavorable) is performed with a minimum amount of perceived delay, it may be desirable to apply a computational efficient predefined determination scheme. When the game is a “gaming reel based game” it may for example be possible to apply different forms of feature detection algorithms that today find usage within e.g. the computer vision field, such as for detecting and describing local features in images. In some embodiments of the present disclosure the predefined determination scheme may be selected to apply e.g. feature descriptors or feature vectors, where the plurality of predefined cluster formations among the gaming reels are expressions of such feature descriptors or feature vectors. Other predefined determination schemes are also possible and within the scope of the present disclosure.

An advantage following the present concept is that unfavorable scores for the player may then be compared to unfavorable scores from other players playing the same game (with individual bets and outcomes) as well as with players playing different games.

Within the context of the present disclosure the expression “forming a graphical representation of the leaderboard” should be interpreted broadly. Specifically, it should be understood that the server in some embodiments may be configured to only form a collection of data (here corresponding to the graphical representation) that will be rendered at the frontend, such as within the GUI of the electronic user device.

However, in another embodiment it may be the other way around, meaning that the server will essentially form an image (here corresponding to the graphical representation) that then will be displayed within the GUI of the electronic user device. Further alternative implementations along the same mutations are possible and within the scope of the present disclosure. Additionally, it should be understood that displaying of the graphical representation of the leaderboard must not necessary include displaying all information, but rather in some embodiment only a (e.g. relevant) portion of the total leaderboard is displayed. It may for example, be possible to select only a portion of the leaderboard where the specific user is present and display this portion to the user.

In an embodiment of the present disclosure, the first score of the first electronic user device is formed by counting the number of consecutive unfavorable outcomes before a favorable outcome. Alternatively the first score of the first electronic user device is formed by counting the number of consecutive unfavorable outcomes and dividing that number by a multiplication factor of a favorable outcome. Both method may be used together.

Possibly, an unfavorable outcome comprises scores that are equal to zero or a score where the multiplication factor of the score and the original bet is equal to or below 5, preferably equal to or below 4 and most preferably equal to and below 3. That is, an unfavorable outcome comprises situations where a player loses his bet or situations where a player places an original bet and wins by a multiplication that is below a threshold i.e. a multiplication factor equal to or below 5 e.g. a player bets 1 Euro and then only scores 2 Euros (i.e. wins but by a multiplication factor of 2). Put differently an unfavorable outcome comprises scores that fall between 0 and a multiplication factor of 5.

On the other hand, a favorable outcome comprises a score where the multiplication factor of the score and original bet is above 5.

In a possible embodiment of the present disclosure, the operation of ranking the plurality of electronic user devices is further based on the game selected by each of the plurality of electronic user devices. For example, different games may be separated into different leaderboards, or different games may be giving different weights in the ranking procedure.

As an example, in one embodiment the determination of the first score for the first electronic user device may be further based on a multiplication factor, where the multiplication factor may be based on a parameter of game selected by the first electronic user device.

In the case of a tie break, the invention provides for the further step of determining a winner of the leaderboard by determining which electronic user device achieved the highest outcome, determining which electronic user device achieved a number of consecutive unfavorable outcome first, determining which electronic user device participated in the leaderboard for the longest time period or the shortest time period or a combination of the above.

The tie break may therefore be score based or time based. Within the scope of the present disclosure it could also be possible to allow the tie breaker or any other similar parameter to be decided by the provider of the game.

The winner of the leaderboard may then for example be provided with a reward. The reward may comprise a prize, a sum of money or free spins for the game.

According to another aspect of the present disclosure there is provided a gaming system comprising a server arranged in communication with a plurality of electronic user devices using a network connection, the plurality of electronic user devices each provided with a display unit adapted to present a graphical user interface (GUI), wherein the server is adapted to receive a request from a first electronic user device of the plurality of electronic user devices to enter into one of a plurality of games provided by the server, the request comprising a selection of a first one of the plurality of games and a bet for the selected first game, execute the first selected game with the bet, determine an outcome of the executed first selected game, determine a first score for the first electronic user device, wherein the first score is determined by at least one of accumulate a number of consecutive unfavorable outcomes before a subsequent favorable outcome, and divide an accumulated number of consecutive unfavorable outcomes by a multiplication factor of a favorable outcome, rank the plurality of electronic user devices in a leaderboard based on a comparison of the first score with a plurality of corresponding scores for the remaining plurality of electronic user devices, including providing each of the plurality of electronic user devices with a ranking level within the leaderboard, wherein a low first score is defined as an unfavorable outcome and is ranked higher than a high first score, and a high first score is defined as a favorable outcome, form a graphical representation of the leaderboard, distribute the graphical representation of the leaderboard, to the plurality of electronic user devices, the graphical representation being adapted to be displayed within the GUI of each of the plurality of electronic user devices and direct, using the server, the plurality of electronic user devices to display the graphical representation of the leaderboard within the GUI of each of the plurality of electronic user devices. This aspect of the present disclosure provides similar advantages and includes similar embodiments as discussed above in relation to the previous aspects of the present disclosure.

Preferably, the gaming system is a cloud-based computing system and the server is a cloud server. Thus, the computing power provided by means of the invention may be distributed between a plurality of servers, and the location of the servers must not be explicitly defined. Advantageous following the use of a cloud-based solution is also the inherent redundancy achieved.

In some embodiments the electronic user devices may be selected to include e.g. a computer (laptop/stationary), a mobile phone, a tablet, a (gaming) consoles or any other gaming device and gambling terminals. The GUI may in some embodiments be allowed to depend on the type of electronic user device.

According to a still further aspect of the present disclosure there is provided a computer program product comprising a computer readable medium having stored thereon computer program means for operating a gaming system, the gaming system comprising a server arranged in communication with a plurality of electronic user devices using a network connection, the plurality of electronic user devices each provided with a display unit adapted to present a graphical user interface (GUI), wherein the computer program product comprises code for receiving, at the server, a request from a first electronic user device of the plurality of electronic user devices to enter into one of a plurality of games provided by the server, the request comprising a selection of a first one of the plurality of games and a bet for the selected first game, code for executing, at the server, the first selected game with the bet, code for determining, at the server, an outcome of the executed first selected game, wherein the outcome can be one of favorable and unfavorable, code for determining, at the server, a first score for the first electronic user device, wherein the first score is determined by at least one of code for accumulating a number of consecutive unfavorable outcomes before a subsequent favorable outcome; and code for dividing an accumulated number of consecutive unfavorable outcomes by a multiplication factor of a favorable outcome, code for ranking, at the server, the plurality of electronic user devices in a leaderboard based on a comparison of the first score with a plurality of corresponding scores for the remaining plurality of electronic user devices, including code for providing each of the plurality of electronic user devices with a ranking level within the leaderboard, wherein a low first score is defined as an unfavorable outcome and is ranked higher than a high first score, and a high first score is defined as a favorable outcome, code for forming, at the server, a graphical representation of the leaderboard, code for distributing, from the server to the plurality of electronic user devices, the graphical representation of the leaderboard, and code for directing, using the server, the plurality of electronic user devices to display the graphical representation of the leaderboard within the GUI of each of the plurality of electronic user devices. Also this aspect of the present disclosure provides similar advantages and includes similar embodiments as discussed above in relation to the previous aspects of the present disclosure.

The computer program product is typically executed using a computing device comprised with the server, preferably including a microprocessor or any other type of computing device. Similarly, a software executed by the server for operating the gaming system may be stored on a computer readable medium, being any type of memory device, including one of a removable non-volatile random access memory, a hard disk drive, a floppy disk, a CD-ROM, a DVD-ROM, a USB memory, an SD memory card, or a similar computer readable medium known in the art. Accordingly, operation of the gaming system may be at least partly automated, implemented as e.g. software, hardware and a combination thereof.

Further features of, and advantages with, the present disclosure will become apparent when studying the appended claims and the following description. The skilled addressee realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates an exemplary electronic gaming system according to a currently preferred embodiment of the present disclosure;

FIG. 2 provides an exemplary illustration of a typical graphical user interface (GUI) for use in playing a game;

FIG. 3 shows an exemplary leaderboard to be presented for a player in conjunction with the present concept, and

FIG. 4 is a flow chart illustrating the exemplary steps for operating an electronic gaming system.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness, and fully convey the scope of the present disclosure to the skilled addressee. Like reference characters refer to like elements throughout.

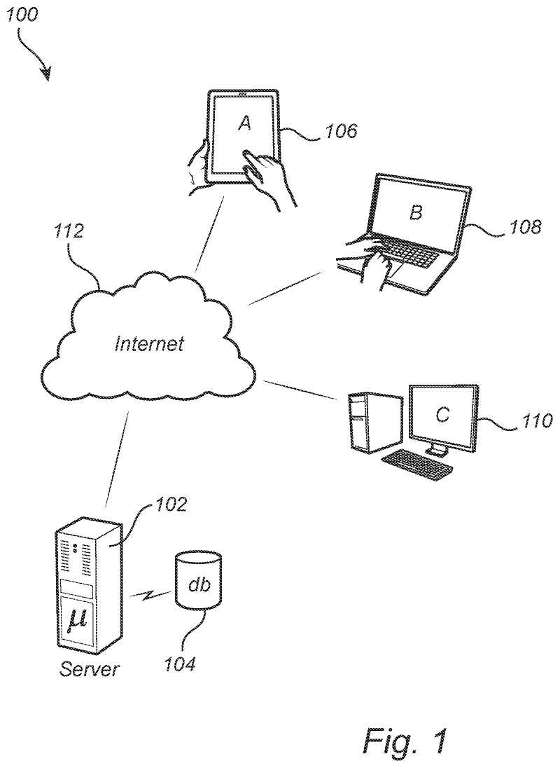

Referring now to the drawings and FIG. 1 in particular, there is depicted a gaming system 100 in which an online game, such as a slot game, may be played according to a currently preferred embodiment of the present disclosure. The system architecture illustrated in FIG. 1 depicts a system environment in which systems, methods, apparatus, computer-readable mediums and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one server 102 and/or at least one gaming database 104. Server 102 and gaming database 104 may be communicably linked to one or more client devices 106, 108, 110, etc. through network 112. The network 112 may be wired or wireless, including for example wired connections like a building LAN, a WAN, an Ethernet network, an IP network, etc., and wireless connections like WLAN, CDMA, GSM, GPRS, 3G mobile communications, 4G mobile communications, Bluetooth, infrared, or similar. As such, the network 112 may be locally and/or globally provided.

The gaming database 104 may be any type of physical unit on which games reside, such as a machine in a gaming venue, a lottery machine, an electronic game system, etc. Network 112 may be implemented as the Internet, or any local or wide area network, either public or private. Network 112 may also be a hardware system physically connecting some or all of the server 102 and client devices 106, 108, 110. Client devices 106, 108, 110 may be implemented as any computing devices such as a personal computing device, a server, a server network, handheld computing device, slot machine, other gaming machine in a gaming venue such as a betting terminal, a gaming console, lottery machine, an interface in a virtual environment, etc.

It may be appreciated by one of ordinary skill in the art that while only one server, one gaming database, one network and two client devices are depicted, more or fewer servers, more or fewer gaming databases, more networks and more or fewer client devices and/or other devices may reside within system 100.

The elements inside system 100 may include one or more (micro) processors, purpose-built hardware such as, for example, FPGA, ASIC, etc., software systems and applications, software packages, mechanical and electrical parts, etc. Software packages that may be part of server 102, gaming database 104, client devices 106, 108, 110 and network 112 may be recorded on a computer readable medium such as a memory device, RAM, CD/DVD/USB drives, handheld memory device, etc., and/or may be part of a physical device such as one or more (microprocessors or electro-mechanical systems. Any of server 102, gaming database 104, client devices 106, 108, 110 and network 112 may be fixed systems, mobile systems, portable systems, or cloud systems (as discussed above).

FIG. 1 shows only three electronic user devices 106, 108, 110, however it should be understood that a general implementation of the present disclosure comprises a large plurality of electronic user devices, possibly greatly above three, such as 100, 1000, 10000, etc.

Although the various components of FIG. 1 are illustrated as discrete elements, it should be recognized that certain operations of some of the various components may be performed by the same physical device, e.g., by one or more microprocessors or other type of devices.

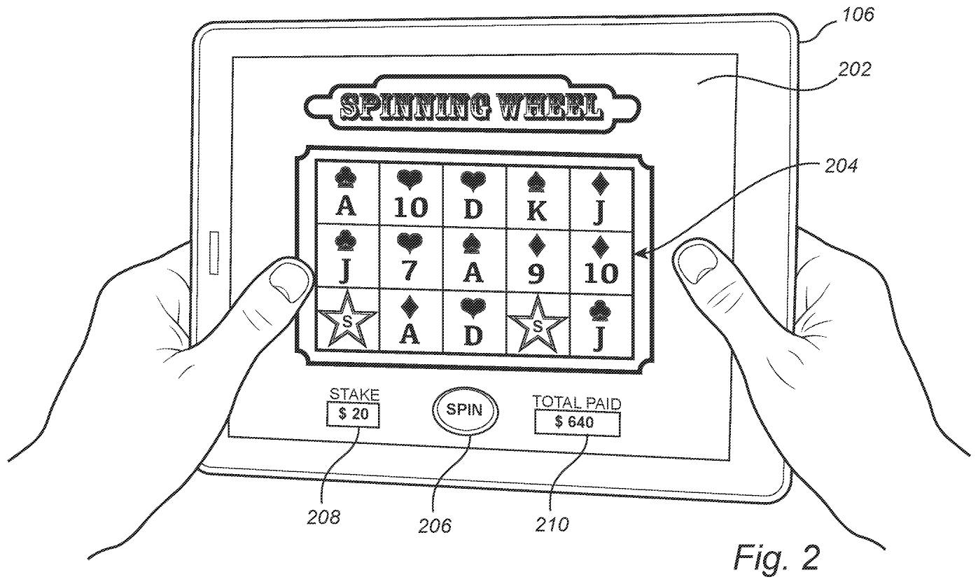

Turning now to FIG. 2 illustrating a graphical user interface (GUI) 202 to be displayed at one of the above discussed client devices 106, 108, 110, in the illustrated embodiment provided as an application (“app”) or within e.g. a web browser of the portable client device 106 being a tablet. The online game of chance to be played within the GUI is in the exemplary illustration a slot game, visualized within the GUI 202 as comprising five individual reels 204 provided with a plurality of different symbols (and various lines). The GUI also comprises a “button” 206 to start the game, here provided with the description “SPIN” for initiating a turn of the game. In addition, the GUI 202 comprises an indicator of the current stake 208 (i.e. payment for each turn of the game) and an indicator of the total payment to the player 210. It should in any case be understood that other types of games may be played within the scope of the present disclosure, for example being skill based as compared to a game of chance.

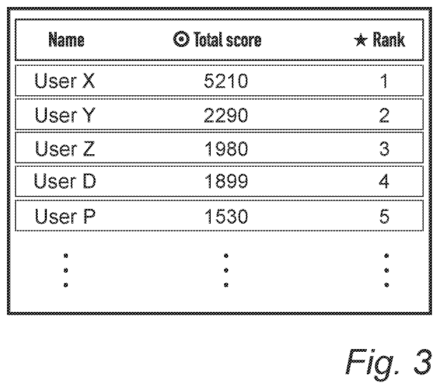

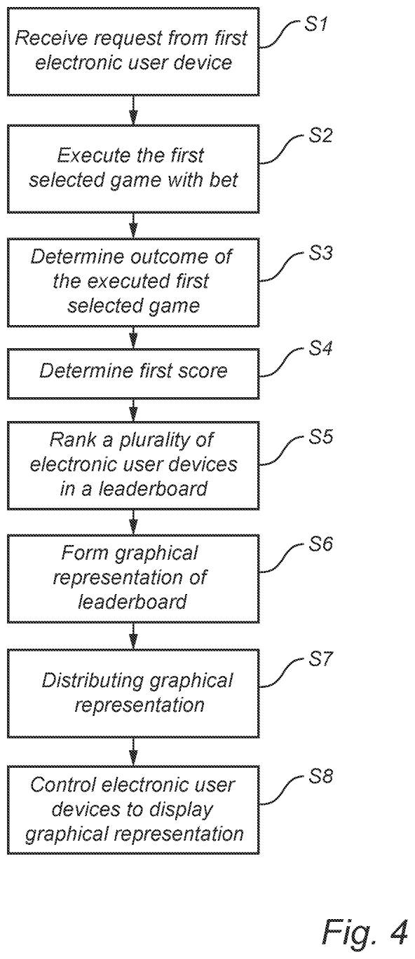

During operation gaming system 100, with further reference to FIGS. 3 and 4, the server 102 receives, S1 a request from a first electronic user device 106 of the plurality of electronic user devices 106, 108, 110 to enter into one of a plurality of games provided by the server 102, such as e.g. the slot game as shown in FIG. 2, or another game of chance, or a game of skill. Further to dictating the desired game to play, the request that is provided from the first electronic user device 106 to the server 102 further comprises a bet for the selected game.

The bet is generally monetary but may be in any form suitable for use in relation to the specific game. It may further be possible to provide the player with e.g. a bonus, promotional free spins, etc.

The server 102 will subsequently execute, S2, the selected game based on the bet. The bet may in some embodiments have a maximum and/or a minimum level, possibly dependent on the type of game to be played. The server 102 will then determine, S3, an outcome of the executed first selected game.

That is, in case for example the player bets $20, the outcome is typically a multiplication factor of the bet, where the multiplication factor possibly may be from 0 to a maximum set for the game. This effectively may result in that the player may get anything from 0×$20 back to maximum multiplication factor×$20 back. That is, the player may lose his bet completely, get a portion of the bet back, get the total bet back, or get more than the bet back. In the case of the present invention a positive outcome comprises a case where the outcome is a multiplication factor above 5 e.g. 6×$20 and an unfavorable outcome is a multiplication factor of 0 and 5 and anything between 0 and 5.

The server 102 will then determine, S4, a first score for the first electronic user device 106 based on the number of consecutive unfavorable outcomes before a favorable outcome, by counting the number of consecutive unfavorable outcomes and dividing that number by a multiplication factor of a favorable outcome or both.

Other calculations are possible and within the scope of the present disclosure, such as for example including a weight being dependent on factors such as time spent playing the game, the type of the game, the total wagering during the promotional period or number of bets (spins), etc.

The score will subsequently be used by the server 102 for determining how badly the specific player performed in relation to other players playing the same or other players, by ranking, S5, the players.

The ranking will additionally include providing each of the plurality of electronic user devices with a ranking level within the leaderboard, such as a number within the leaderboard. In an embodiment of the present disclosure the request comprises an opt-in to join the leaderboard.

As such, only players having opted in may be ranked. Accordingly, the server 102 may implement a functionality to ensure that only opted in players are included in the leaderboard.

Still further, it may be possible to only allow specific geographical areas to be included with the leaderboard, for example dependent on specific jurisdictions for the geographical area where the player is located.

The invention further provides a mechanism in case of a tie break where two or more players end up with the same score. In such an instance a winner can be chosen by taking into account aspects comprising time factors or score factors. For example a winner can be determined by determining which player achieved the highest favorable outcome after the consecutive wins, which player achieved the favorable outcome first or which player participated in the leaderboard for the longest period of time or the shortest period of time. The invention also provides for combinations of the above which again can be selected by operators of the game.

Based on the ranking, the server 102 may form, S6, a graphical representation of the leaderboard that is to be distributed, S7, from the server 102 to the plurality of electronic user devices 106, 108, 110, whereby the server controls, S8, the plurality of electronic user devices to display the graphical representation of the leaderboard is subsequently to be displayed within the GUI of each of the plurality of electronic user devices 106, 108, 110. The graphical representation must not necessarily include the exact information to be presented within the GUI of each of the plurality of electronic user devices 106, 108, 110. Rather, representative data may be provided from the server 102 to the plurality of electronic user devices 106, 108, 110, allowing rendering to be performed at the plurality of electronic user devices 106, 108, 110 for display within the respective GUIs.

As is shown in FIG. 3, the leaderboard can include the individual users, their score and their rank.

In summary, the present disclosure relates to a computer implemented method performed by a gaming system, the gaming system comprising a server arranged in communication with a plurality of electronic user devices using a network connection, the plurality of electronic user devices each provided with a display unit adapted to present a graphical user interface (GUI), wherein the method comprises the steps of receiving, at the server, a request from a first electronic user device of the plurality of electronic user devices to enter into one of a plurality of games provided by the server, the request comprising a selection of a first one of the plurality of games and a bet for the selected first game, executing, at the server, the first selected game with the bet, determining, at the server, an outcome of the executed first selected game, determining, at the server, a first score for the first electronic user device based on a comparison of the bet and the outcome, ranking, at the server, the plurality of electronic user devices in a leaderboard based on a comparison of the first score with a plurality of corresponding scores for the remaining plurality of electronic user devices, including providing each of the plurality of electronic user devices with a ranking level within the leaderboard, wherein a low first score is defined as an unfavorable outcome and is ranked higher than a high first score, and a high first score is defined as a favorable outcome, forming, at the server, a graphical representation of the leaderboard, distributing, from the server to the plurality of electronic user devices, the graphical representation of the leaderboard, and controlling, using the server, the plurality of electronic user devices to display the graphical representation of the leaderboard within the GUI of each of the plurality of electronic user devices.

Advantages with the present disclosure includes an improved attraction to the gaming concept by providing a novel way for players operating individual electronic user devices and possibly playing different games to share a common leaderboard, where the individual players may be ranked based on unfavorable outcomes and compared to each other. In line with the present disclosure, the bet placed by an individual player (operating his electronic user device) and the outcome of the bet will be used to form a specific score for that player playing a specific game.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon.

Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium.

Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

1. A computer implemented method performed by a gaming system, the gaming system comprising a server arranged in communication with a plurality of electronic user devices using a network connection, the plurality of electronic user devices each provided with a display unit adapted to present a graphical user interface (GUI), wherein the method comprises:
receiving, at the server, a request from a first electronic user device of the plurality of electronic user devices to enter into one of a plurality of games provided by the server, the request comprising a selection of a first one of the plurality of games and a bet for the selected first game;
executing, at the server, the first selected game with the received bet;
determining, at the server, an outcome of the executed first selected game, wherein the outcome can be one of favorable and unfavorable;
determining, at the server, a first score for the first electronic user device, wherein the first score is determined by at least one of:
accumulating a number of consecutive unfavorable outcomes before a subsequent favorable outcome; and
dividing an accumulated number of consecutive unfavorable outcomes by a multiplication factor of a favorable outcome;
ranking, at the server, the plurality of electronic user devices in a leaderboard based on a comparison of the first score with a plurality of corresponding scores for the remaining plurality of electronic user devices, including providing each of the plurality of electronic user devices with a ranking level within the leaderboard, wherein a low first score is defined as an unfavorable outcome and is ranked higher than a high first score, and a high first score is defined as a favorable outcome;
forming, at the server, a graphical representation of the leaderboard,
distributing, from the server to the plurality of electronic user devices, the graphical representation of the leaderboard, and
directing, using the server, the plurality of electronic user devices to display the graphical representation of the leaderboard within the GUI of each of the plurality of electronic user devices.

2. The method of claim 1, wherein the first score of the first electronic user device is further dependent on counting the number of consecutive unfavorable outcomes before a subsequent favorable outcome, by counting the number of consecutive unfavorable outcomes and dividing that number by a multiplication factor of a favorable outcome, or both.

3. The method according to claim 2, wherein an unfavorable outcome comprises either a zero score or a score where the multiplication factor of the score and the original bet is equal to or below 5, preferably below 4 and most preferably below 3.

4. The method of claim 2, wherein a favorable outcome comprises a score where the multiplication factor of the score and original bet is above 5.

5. The method of claim 1, comprising in the case of a tie break determining a winner of the leaderboard by:
determining which electronic user device achieved the highest favorable outcome,
determining which electronic user device achieved the number of consecutive unfavorable outcomes first,
determining which electronic user device participated in the leaderboard for the longest time period or the shortest time period, or
a combination of the three.

6. The method according to claim 1, wherein ranking the plurality of electronic user devices is further based on a predetermined weight given to the game selected by each of the plurality of electronic user devices.

7. A gaming system comprising a server arranged in communication with a plurality of electronic user devices using a network connection, the plurality of electronic user devices each provided with a display unit adapted to present a graphical user interface (GUI), wherein the server is adapted to:
receive a request from a first electronic user device of the plurality of electronic user devices to enter into one of a plurality of games provided by the server, the request comprising a selection of a first one of the plurality of games and a bet for the selected first game;
execute the first selected game with the bet;
determine an outcome of the executed first selected game, wherein the outcome can be one of favorable and unfavorable;
determine a first score for the first electronic user device wherein the first score is determined by at least one of:
accumulate a number of consecutive unfavorable outcomes before a subsequent favorable outcome; and
divide an accumulated number of consecutive unfavorable outcomes by a multiplication factor of a favorable outcome;
rank the plurality of electronic user devices in a leaderboard based on a comparison of the first score with a plurality of corresponding scores for the remaining plurality of electronic user devices, including providing each of the plurality of electronic user devices with a ranking level within the leaderboard, wherein a low first score is defined as an unfavorable outcome and is ranked higher than a high first score, and a high first score is defined as a favorable outcome;
form a graphical representation of the leaderboard,
distribute the graphical representation of the leaderboard to the plurality of electronic user devices, the graphical representation being adapted to be displayed within the GUI of each of the plurality of electronic user devices, and
directing, using the server, the plurality of electronic user devices to display the graphical representation of the leaderboard within the GUI of each of the plurality of electronic user devices.

8. The gaming system according to claim 7, wherein the first score of the first electronic user device is formed by counting the number of consecutive unfavorable outcomes before a subsequent favorable outcome, by counting the number of consecutive unfavorable outcomes and dividing that number by a multiplication factor of a favorable outcome or both.

9. The gaming system according to claim 8, wherein an unfavorable outcome comprises either a zero score or a score where the multiplication factor of the score and the original bet is equal to or below 5, preferably below 4 and most preferably below 3.

10. The gaming system according to claim 8, wherein a favorable outcome comprises a score where the multiplication factor of the score and original bet is above 5.

11. The gaming system according to claim 7, wherein, in the case of a tie break the server is further adapted to determine a winner of the leaderboard by:
determining which electronic user device achieved the highest favorable outcome,
determining which electronic user device achieved the number of consecutive unfavorable outcomes first,
determining which electronic user device participated in the leaderboard for the longest time period, or
a combination of the three.

12. A computer program product comprising a non-transitory computer readable medium having stored thereon computer program means for operating a gaming system, the gaming system comprising a server arranged in communication with a plurality of electronic user devices using a network connection, the plurality of electronic user devices each provided with a display unit adapted to present a graphical user interface (GUI), wherein the computer program product comprises:
code for receiving, at the server, a request from a first electronic user device of the plurality of electronic user devices to enter into one of a plurality of games provided by the server, the request comprising a selection of a first one of the plurality of games and a bet for the selected first game;
code for executing, at the server, the first selected game with the bet;
code for determining, at the server, an outcome of the executed first selected game;
code for determining, at the server, a first score for the first electronic user device, wherein the first score is determined by at least one of:
code for accumulating a number of consecutive unfavorable outcomes before a subsequent favorable outcome; and
code for dividing an accumulated number of consecutive unfavorable outcomes by a multiplication factor of a favorable outcome;
code for ranking, at the server, the plurality of electronic user devices in a leaderboard based on a comparison of the first score with a plurality of corresponding scores for the remaining plurality of electronic user devices, including code for providing each of the plurality of electronic user devices with a ranking level within the leaderboard, wherein a low first score is defined as an unfavorable outcome and is ranked higher than a high first score, and a high first score is defined as a favorable outcome;
code for forming, at the server, a graphical representation of the leaderboard,
code for distributing, from the server to the plurality of electronic user devices, the graphical representation of the leaderboard, and
code for directing, using the server, the plurality of electronic user devices to display the graphical representation of the leaderboard within the GUI of each of the plurality of electronic user devices.
